(19) United States
(12) Patent Application Publication
(10) Pub. No.: US 2026/0236062 A1
(43) Pub. Date: Aug. 13, 2026

(54) MODE SELECTOR WITH ROTATABLE DISPLAY

(71) Applicant: Also, Inc., Palo Alto, CA (US)

(72) Inventors: Arth Nireshkumar PATEL, San Jose, CA (US); Adam Christopher BENDER, San Francisco, CA (US)

(73) Assignee: Also, Inc., Palo Alto, CA (US)

(21) Appl. No.: 19/536,909

(22) Filed: Feb. 11, 2026

Related U.S. Application Data
(60) Provisional application No. 63/757,442, filed on Feb. 12, 2025.

(51) Int. Cl. G06F 1/16

(52) U.S. Cl. CPC G06F 1/1616; G06F 1/1647

(57) ABSTRACT

An assembly can include a housing. The housing can receive (i) a display assembly and (ii) a carrier assembly. The display assembly can include a selector element. The selector element can adjust a micromobility device between one or more modes to change one or more operations of the micromobility device. The display assembly can include a display device. The display device can present information associated with the micromobility device. The display assembly can be movably coupled with the carrier assembly such that the selector element and the display device move independent from the carrier assembly. The carrier assembly can electrically couple the display assembly with one or more components of the micromobility device. The carrier assembly can provide structural support to the display assembly.

### CROSS-REFERENCE TO RELATED PATENT APPLICATIONS

This application claims the benefit of and priority to U.S. Provisional Patent Application No. 63/757,442, filed February 12, 2025, the entirety of which is incorporated by reference herein for all purposes.

### BACKGROUND

Micromobility devices, such as bicycles can include one or more portions.

### SUMMARY

This disclosure is generally related to one or more components for a micromobility device such as a bicycle. The components can include at least one assembly. The assembly can include one or more additional assemblies or sub-assemblies. For example, the assembly can include a selector element to adjust one or more modes of the bicycle. The selector element can adjust the bicycle from a first mode to a second mode. For example, the selector element can adjust the bicycle to a driver assist mode which provides propulsion to move the bicycle. As another example, the selector element can adjust the bicycle to a locked mode or other possible inoperable mode. The assembly can include a display device which moves in unison with or in conjunction with the selector element. For example, the selector element and the display device can both rotate about a similar axis.

At least one aspect is directed to an assembly. The assembly can be for a bicycle. The assembly can include a housing. The housing can receive (i) a display assembly and (ii) a carrier assembly. The display assembly can include a selector element. The selector element can adjust the bicycle between one or more modes to change one or more operations of the bicycle. The display assembly can include a display device. The display device can present information associated with the bicycle. The display assembly can be movably coupled with the carrier assembly such that the selector element and the display device move independent from the carrier assembly. The carrier assembly can electrically couple the display assembly with one or more components of the bicycle. The carrier assembly can provide structural support to the display assembly.

At least one aspect is directed to a bicycle. The bicycle can include an assembly. The assembly can include a housing. The housing can receive (i) a display assembly and (ii) a carrier assembly. The display assembly can include a selector element. The selector element can adjust the bicycle between one or more modes to change one or more operations of the bicycle. The display assembly can include a display device. The display device can present information associated with the bicycle. The display assembly can be movably coupled with the carrier assembly such that the selector element and the display device move independent from the carrier assembly. The carrier assembly can electrically couple the display assembly with one or more components of the bicycle. The carrier assembly can provide structural support to the display assembly.

At least one aspect is directed to a method. The method can include providing an assembly. The assembly can be for a bicycle. The assembly can include a housing. The housing can receive (i) a display assembly and (ii) a carrier assembly. The display assembly can include a selector element. The selector element can adjust the bicycle between one or more modes to change one or more operations of the bicycle. The display assembly can include a display device. The display device can present information associated with the bicycle. The display assembly can be movably coupled with the carrier assembly such that the selector element and the display device move independent from the carrier assembly. The carrier assembly can electrically couple the display assembly with one or more components of the bicycle.

At least one aspect is directed to a method. The method can include providing a housing of an assembly for a bicycle. The housing can receive (i) a display assembly and (ii) a carrier assembly. The method can include movably coupling the display assembly with the carrier assembly such that a selector element of the display assembly and a display device of the display assembly move independent from the carrier assembly. The method can include electrically coupling, via the carrier assembly, the display assembly with one or more components of the bicycle. The method can include providing, via the carrier assembly, structural support to the display assembly.

At least one aspect is directed to a method. The method can include receiving, by a housing of an assembly for a bicycle, a display assembly and a carrier assembly. The method can include movably coupling the display assembly with the carrier assembly such that the selector element and the display device move independent from the carrier assembly. The method can include adjusting, by a selector element of the display assembly, the bicycle between one or more modes to change one or more operations of the bicycle. The method can include presenting, by a display device of the display assembly, information associated with the bicycle. The method can include electrically coupling the carrier assembly with one or more components of the bicycle. The method can include providing, by the carrier assembly, structural support to the display assembly.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example bicycle, in accordance with some aspects.

FIG. 2 depicts the example bicycle of FIG. 1, in accordance with some aspects.

FIG. 3A depicts an assembly, in accordance with some aspects.

FIG. 3B depicts the assembly of FIG. 3A, in accordance with some aspects.

FIG. 3C depicts the assembly of FIG. 3A, in accordance with some aspects.

FIG. 3D depicts the assembly of FIG. 3A coupled with a handlebar of the bicycle of FIG. 1, in accordance with some aspects.

FIG. 4 depicts a perspective view of the assembly of FIG. 3A, in accordance with some aspects.

FIG. 5A depicts the assembly of FIG. 3A, in accordance with some aspects.

FIG. 5B depicts the assembly of FIG. 3A, in accordance with some aspects.

FIG. 6 depicts the assembly of FIG. 3A, in accordance with some aspects.

FIG. 7A depicts a cross-sectional view of the assembly of FIG. 3A, in accordance with some aspects.

FIG. 7B depicts a cross-sectional view of the assembly of FIG. 3A, in accordance with some aspects.

FIG. 8A depicts a perspective view of the assembly of FIG. 3A, in accordance with some aspects.

FIG. 8B depicts a perspective view of the assembly of FIG. 3A, in accordance with some aspects.

FIG. 9A depicts a display assembly included in the assembly of FIG. 3A, in accordance with some aspects.

FIG. 9B depicts a display assembly included in the assembly of FIG. 3A, in accordance with some aspects.

FIG. 9C depicts a display assembly included in the assembly of FIG. 3A, in accordance with some aspects.

FIG. 10 depicts a perspective view of a carrier assembly included the assembly of FIG. 3A, in accordance with some aspects.

FIG. 11A depicts the carrier assembly of FIG. 10, in accordance with some aspects.

FIG. 11B depicts the carrier assembly of FIG. 10, in accordance with some aspects.

FIG. 12A depicts the carrier assembly of FIG. 10, in accordance with some aspects.

FIG. 12B depicts the carrier assembly of FIG. 10, in accordance with some aspects.

FIG. 13A depicts the carrier assembly of FIG. 10, in accordance with some aspects.

FIG. 13B depicts the carrier assembly of FIG. 10, in accordance with some aspects.

FIG. 14A depicts the carrier assembly of FIG. 10, in accordance with some aspects.

FIG. 14B depicts the carrier assembly of FIG. 10, in accordance with some aspects.

FIG. 15 is a block diagram illustrating an architecture for a computer system that can be employed to implement elements of the systems and methods described and illustrated herein.

FIG. 16 is a block diagram of a process to provide an assembly, in accordance with some aspects.

FIG. 17 is a block diagram of a process for an assembly of a bicycle, in accordance with some aspects.

### DETAILED DESCRIPTION

Following below are more detailed descriptions of various concepts related to, and implementations of, methods, apparatuses, and systems of one or more assemblies for a bicycle. The various concepts introduced above and discussed in greater detail below may be implemented in any one of a numerous ways.

The present disclosure is directed to one or more components for a micromobility device such as a bicycle. The components can include one or more assemblies or elements for the bicycle, such as a selector element or a display assembly. The display assembly can rotate or otherwise move with the selector element such that an image or other graphical illustration, presented by the display assembly, is oriented upwards. For example, even when the display element is rotated by 90 degrees, a graphical image, presented by the display element, will be presented as if the display element had not been rotated. As another example, the graphical image can be adjusted or otherwise modified such that the position or placement of the graphical image can be maintained even as the display assembly is rotated or otherwise moved.

Bicycles or other rideable micromobility vehicles can include rotary knobs (or other selectable elements) and display elements, however the display elements can be static or stationary relative to the rotary knobs. Stated otherwise, the rotary knobs move relative to or independent of the display elements. Given that the rotary knobs move independent from the display elements, challenges arise in that the display elements and electronics thereof must be sealed or otherwise isolated from an external environment. Moreover, given that the rotary knob moves, a gap or space between the rotary knob and the display element may be required or else the rotary knob would not easily move.

The gaps between the rotary knobs and the display elements further increase the challenges in maintaining a seal between internal electronics and an external environment. For example, dust and water can easily creep into the electronics if the electronics are not properly sealed. Additionally, in order to support or maintain the gap between the rotary knobs and the display elements, additional elements are added to an overall assembly.

Other rotary knobs can include detents which represent difference stages or selections for a mode of a bicycle. Other display elements can further include or present a user interface or user experience for which the modes of the bicycle can be adjusted or otherwise selected. The detents can typically be achieved using at least one of a spring loaded plunger mechanism, a pre-loaded leaf spring, a wire mechanism, or producing reverse/resistive torque in an active haptic setup.

The disclosed solutions have a technical advantage of providing an assembly which includes a selector element integrated with a display element. The selector element can serve as a seal for display element. Moreover, the selector element and the display element can move in unison or uniformly such that a gap is not present between the selector element and the display element. Stated otherwise, the display element is a rotating component which is integrated with or provided with a selector element.

Systems and methods of some of the technical solutions can include utilizing biasing elements (such as magnets or springs) as detents, which can provide haptic feedback to an operator of the selector element. The inclusion of biasing elements (such as magnets or springs) reduce assembly complexity and further provides a dampened feel. Moreover, the springs can store (as a result of rotation of the selector element) potential energy to provide for an automated return of the selector element via the springs. The springs can store potential energy to return selector element to a previous or prior position. Connectors or other cables of the assembly can be provided as a dynamic or flexible elements that wind or unwind based on movements or rotations of the selector element. For example, the connectors can be a flat printed circuit board cable which provides movement flexibility and included integrated connectors.

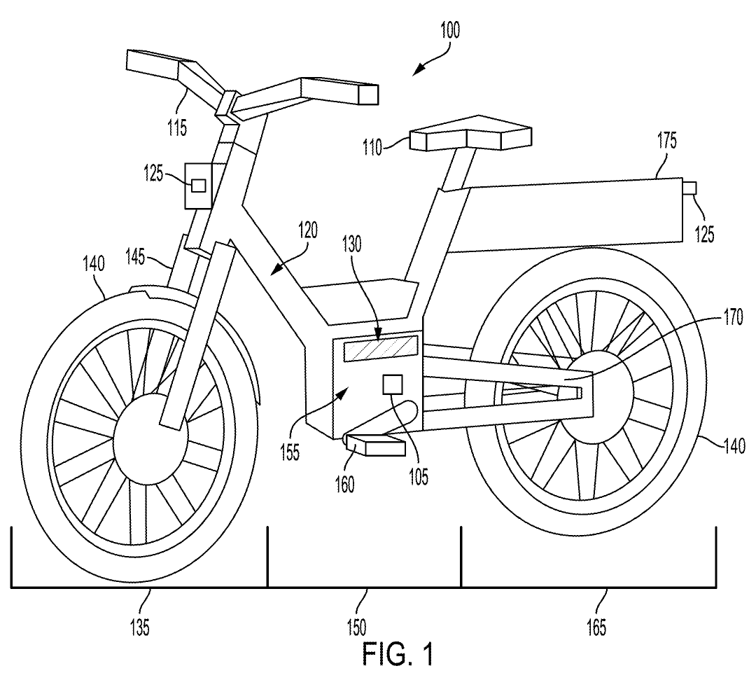

FIG. 1 depicts an example perspective view of a micromobility device such as a bicycle (referred to generally herein as bike 100, which is understood to include a reference to any micromobility device). The bike 100 can be an electric bike installed with at least one battery pack 105. The bike 100 can include at least one bicycle. The bike 100 can be a human-operated bike. The bike 100 can include single rider bicycles, tandem bicycles, cargo bicycles, motor-assist bicycles, pedicabs, electric-assist bicycles, road bicycles, mountain bicycles, or unicycles, among others. The battery pack 105 can also be used as an energy storage system to power a building, such as a residential home or commercial building. The bike 100 can be fully electric or partially electric (e.g., pedal-powered) and further, the bike 100 can be fully autonomous, partially autonomous, semi-autonomous, or unmanned. The bike 100 can also be human operated or non-autonomous. A human operator or the rider of the bike 100 can sit on a seat 110 to operate the bike 100. The rider of the bike 100 can steer, grip, balance, or otherwise control the bike 100 using the handlebar 115. The rider or operator of the bike 100, for which the seat 110 can support, can refer to or include a primary occupant of the bike 100.

The bike 100 can include a frame 120. The frame 120 can support various components of the bike 100, such as a handlebar 115, the seat 110, the battery pack 105, at least one light 125, and at least one lock assembly 130. The frame 120 can refer to or include one or more of a down tube or stem of the bike 100. For example, the frame 120 can include an element or member that spans downward from a front section of the bike 100 and towards a middle section of the bike 100. The frame 120 can span a front portion 135. The front portion 135 can support, be coupled with, or include, for example, a wheel 140 of the bike 100, a fork 145 of the bike 100, the handlebar 115, the light 125, among other components. The bike 100 can include two or more wheels 140 (e.g., a front wheel 140 and a rear wheel 140). The frame 120 can span a middle portion 150. The middle portion 150 can support, be coupled with, or include, for example, the seat 110, the battery pack 105, a crank shaft or a drive mechanism 155 of the bike 100, or a pedal 160 of the bike 100, among other components. The frame 120 can include the middle portion 150 including the lock assembly 130. The frame 120 can include a rear portion 165. The rear portion 165 can support, be coupled with, or include, for example, a rear wheel 140 of the bike 100, the light 125, a drive train 170 of the bike 100, a rack assembly 175 of the bike 100, or among other components. The battery pack 105 can be disposed anywhere within the frame 120.

The battery pack 105 can include at least one battery, at least one battery module, or at least one battery cell. The battery pack 105 can be electrically coupled with the bike 100 (e.g., to the drive mechanism 155, to the light 125, the lock assembly 130, or some other components). For example, the battery pack 105 can provide electrical energy to the bike 100 to power the bike 100. The battery pack 105 can be installed or placed within the bike 100. For example, the battery pack 105 can be installed on the frame 120 of the bike 100 within one or more of the front portion 135, the middle portion 150, or the rear portion 165. The battery pack 105 can be integrally coupled with the frame 120 such that it is not removable. The battery pack 105 can be detachably coupled with the frame 120 such that in can be removed (e.g., to charge the battery pack 105). The battery pack 105 can include or connect with at least one busbar, e.g., a current collector element. For example, the busbar can include electrically conductive material to connect or otherwise electrically couple the battery pack 105 with other electrical components of the bike 100 to provide electrical power to various systems or components of the bike 100, such as the lock assembly 130 or some other system.

The bike 100 can include the lock assembly 130 electrically coupled with the battery pack 105. For example, the battery pack 105 can be electrically coupled with a receiver of the lock assembly 130 to facilitate the actuation or movement of one or more components of the receiver. In this way, the receiver can be configured to be controlled or actuated electronically via power provided by the battery pack 105, rather than being controlled or actuated manually or mechanically (e.g., via some manual action of an operator). For example, the battery pack 105 can provide power to the drive mechanism 155 to power the bike 100 (e.g., propel the bike by causing the at least one wheel 140 to rotate) and also provide power to the receiver to operate the lock assembly 130. The battery pack 105 can provide power to the lock assembly 130 and other components of the bike 100 (e.g., the drive mechanism 155, the light 125, or some other component) simultaneously, separately, in sequence, or in some other manner.

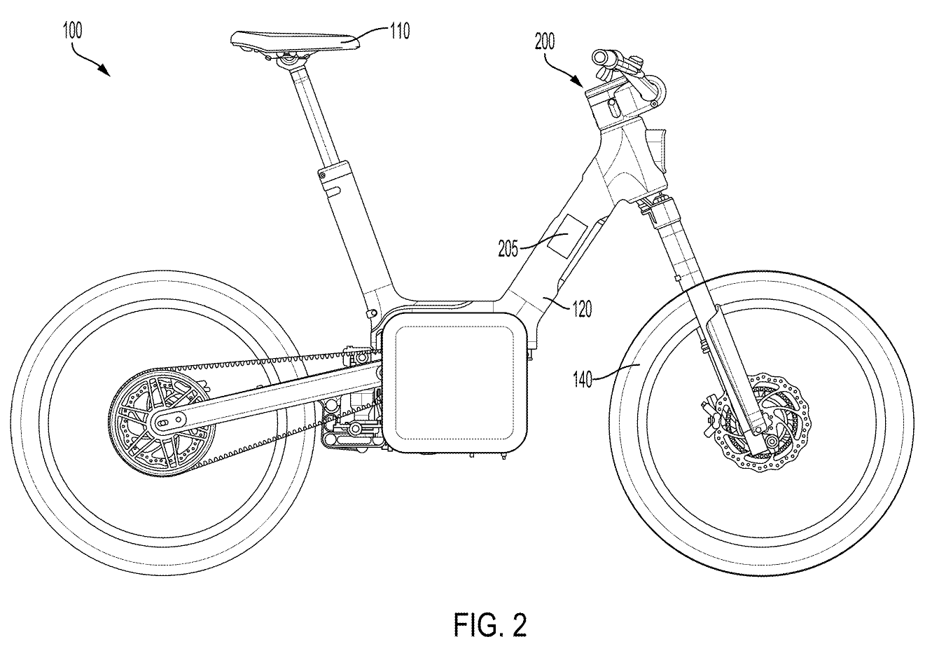

FIG. 2 depicts a view of the bike 100, in accordance with some aspects. The view of the bike 100, as shown in FIG. 2, can refer to or include a side-view. The bike 100 or one or more components thereof can include sub-components, elements, or members. For example, as shown in FIG. 2, the bike 100 includes an assembly 200 and a controller 205. The assembly 200 can include at least one assembly or component thereof as described herein. For example, the assembly 200 can include one or more selector elements, such as a bezel, a rotary knob, a dial ring, among other possibilities. As another example, the assembly 200 can include a display assembly. The controller 205 can refer to or include one or more of at least one processor coupled with memory, one or more processing circuits, electronic processing units (e.g., CPU, GPU, accelerators, etc.), or electrical circuitry to implement one or more functions or operations described herein.

The assembly 200 can be located at or disposed on one or more portions or areas of the bike 100. For example, as shown in FIG. 2, the assembly 200 is located proximate to the handlebar 115. As another example, the assembly 200 can be disposed on a down tube or stem of the bike 100 (e.g., the frame 120). Stated otherwise, the assembly 200 can be mounted to or otherwise attached to the frame 120. The assembly 200 can be coupled with one or more components of the bike 100. For example, the assembly 200 can be electrically coupled with the battery pack 105 such that the assembly 200 can receive electrical energy from the battery pack 105. As another example, the assembly 200 can be communicably coupled with the drive train 170 such that assembly 200 can send to or receive signals from the drive train 170. As another example, the assembly 200 can be communicably coupled with a computing device or processing circuitry which controls operation of the bike 100.

The assembly 200 can be integrated with the handlebar 115 such that at least a portion or segment of the assembly 200 is unified with the handlebar 115. Stated otherwise, a housing or other possible assembly (which defines the handlebar 115) can include at least a portion of the assembly 200 (e.g., the assembly 200 is included in or disposed within a housing of the handlebar 115).

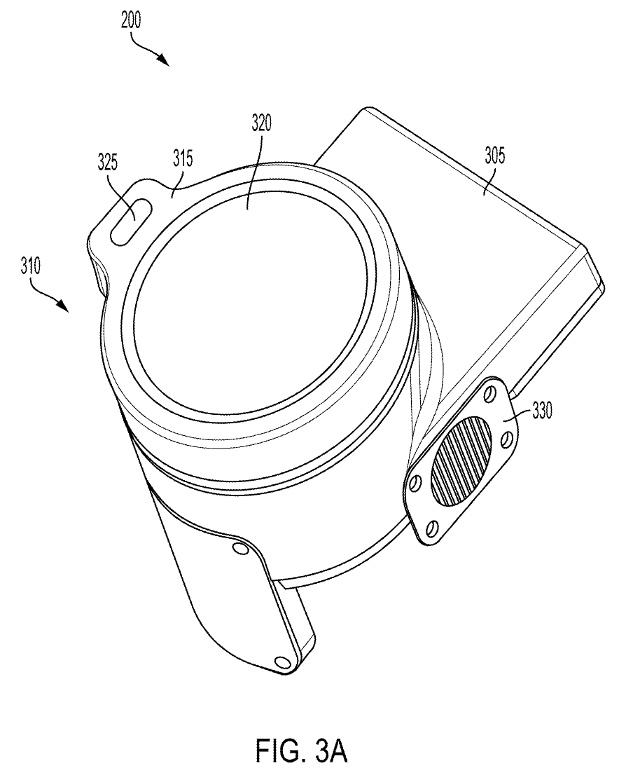

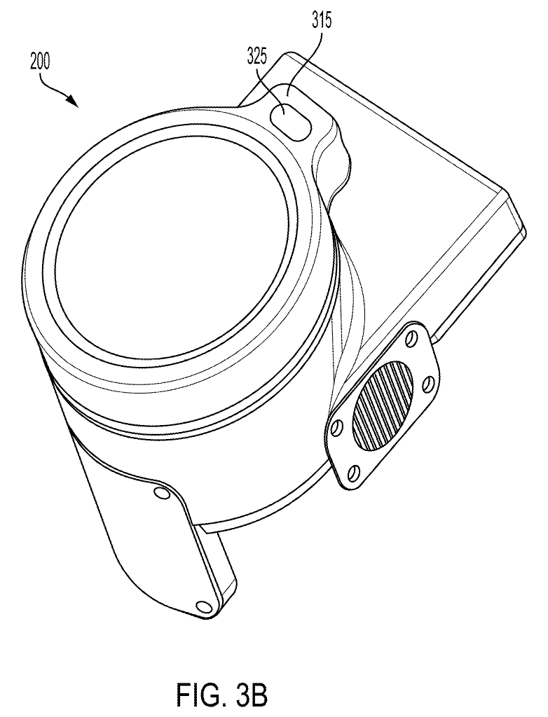

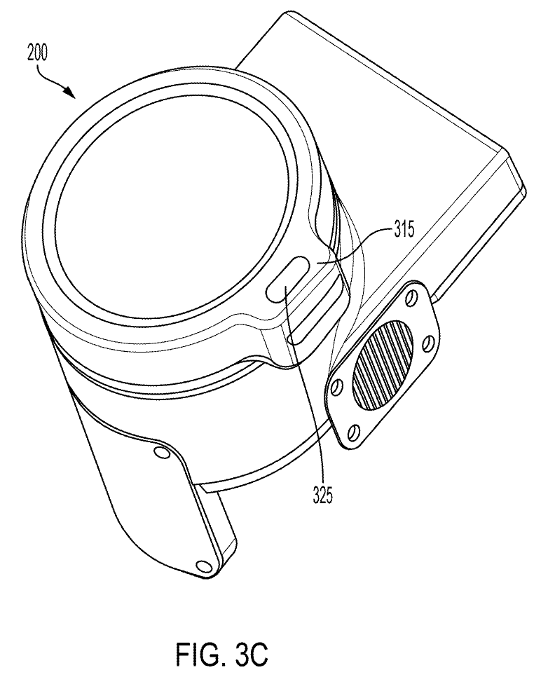

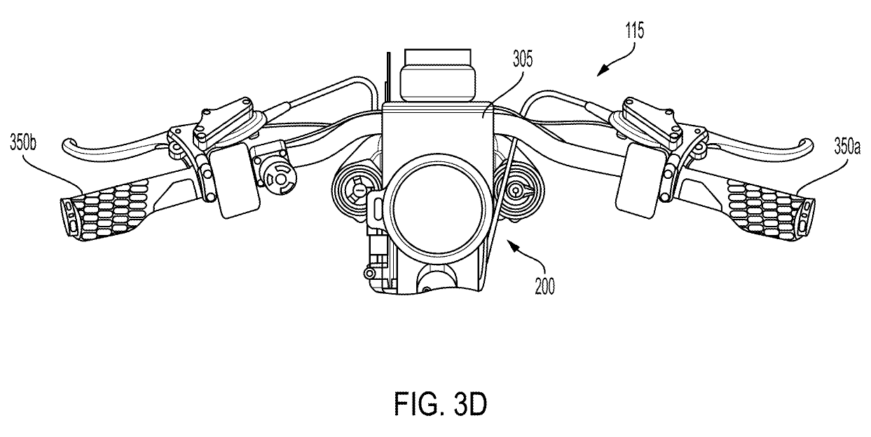

FIGS. 3A-3D depict the assembly 200, in accordance with some aspects. The assembly 200 can include one or more components, sub-components, assemblies, sub-assemblies, or other possible modules. For example, as shown in FIG. 3A, the assembly 200 includes a housing 305. The housing 305 can define or establish at least one of a shape, an area, a dimension, or proportions of the assembly 200. For example, the housing 305 can define an appearance or overall size of the assembly 200. The housing 305 can include one or more recesses, voids, cavities, openings, or apertures to receive one or more components of the assembly 200.

The housing 305 can receive at least on display assembly 310. For example, the display assembly 310 can be inserted into or otherwise placed within an opening of the housing 305. As another example, the display assembly 310 can be coupled with or otherwise secured to the housing 305. The display assembly 310 can include at least one selector element 315 and at least one display device 320. The selector element 315 can include one or more of a bezel, a rotary knob, or a dial ring. For example, the selector element 315 can include a rotary knob to rotate or otherwise move in unison with one or more components of the display assembly 310. The selector element 315 can adjust the bike 100 between one or more modes. For example, the selector element 315 can pivot, rotate, or otherwise move to adjust a mode of the bike 100. The selector element 315 can adjust the bike 100 between a locked state (e.g., a first mode) to a powered state (e.g., a second mode). For example, the selector element 315 can rotate (about a central axis of the display assembly 310) by 90 degrees (or other possible angular amount) to switch the bike 100 from the locked stated to the powered state.

The selector element 315 can change one or more operations of the bike 100 responsive to adjusting the modes of the bike 100. For example, the selector element 315 can dictate when electrical energy is provided, by the battery pack 105, to the drive train 170. As another example, the selector element 315 can dictate whether the lock assembly 130 is activated or deactivated. The selector element 315 can include at least one mode indicator 325. The mode indicator 325 can present or otherwise indicate a mode of the bike 100. For example, the mode indicator 325 can include one or more light sources (e.g., light emitting diodes, halogen lights, illuminating elements, etc.) which can emit light or color to indicate a mode of the bike 100. The mode indictor 325 can emit a first color or light pattern to indicate a first mode of the bike 100. As another example, the mode indicator 325 can emit a second color or light pattern to indicate a second mode of the bike 100.

The display device 320 can include at least one of a screen, a monitor, a graphical device, or other possible device which can present information. For example, the display device 320 can include a liquid crystal display (LCD) screen that can present or otherwise provide graphical information (e.g., images, pictures, graphical illustrations, digital information, etc.). The display device 320 can present information associated with the bike 100. For example, the display device 320 can present a graphical element which indicates a speed of the bike 100. As another example, the display device 320 can present a graphical element which indicates a state of charge of one or more batteries of the battery pack 105. As another example, the display device 320 can present a graphical element which provide navigation information to an operator of the bike 100. The display device 320 can display, generate, or otherwise provide one or more graphical user interfaces to provide information. For example, the display device 320 can generate a graphical user interface to display a graphical or digital image which indicates a mode of the bike 100.

FIGS. 3A-3C depict exemplary examples of the selector element 315 being located in or placed in one or more positions. For example, as shown in FIG. 3A, the selector element 315 is located in a first position or first orientation. As another example, as shown in FIG. 3B, the selector element 315 is located in a second position or second orientation. As another example, as shown in FIG. 3C, the selector element 315 is located in a third position or third orientation. The various positions of the selector element 315 can dictate a mode of the bike 100. For example, the position of the selector element 315, as shown in FIG. 3A, can represent the bike 100 being in a service mode. As another example, the position of the selector element 315, as shown in FIG. 3B, can represent the bike 100 being in a lock mode. As another example, the selector element 315, as shown in FIG. 3C, can represent the bike 100 being in a ride/toggle mode.

As the selector element 315 is moved or rotated by one or more degrees, the display device 320 (as a result of being coupled or integrated with the selector element 315) can be moved or rotated in unison with the selector element 315. For example, a rotation of 15 degrees of the selector element 315 can result in a rotation of 15 degrees by the display device 320.

The housing 305 can be coupled with one or more portions or segments of the bike 100. For example, as shown in FIG. 3D, the housing 305 is coupled with a portion or segment of the bike 100 that is disposed between a first handle 350a and a second handle 350b. Stated otherwise, the housing 305 can be coupled with a center or middle portion of the handlebar 115. The housing 305 can be coupled with one or more alternative or additional portions or segments of the bike 100. For example, the housing 305 can be coupled with the frame 120 of the bike 100.

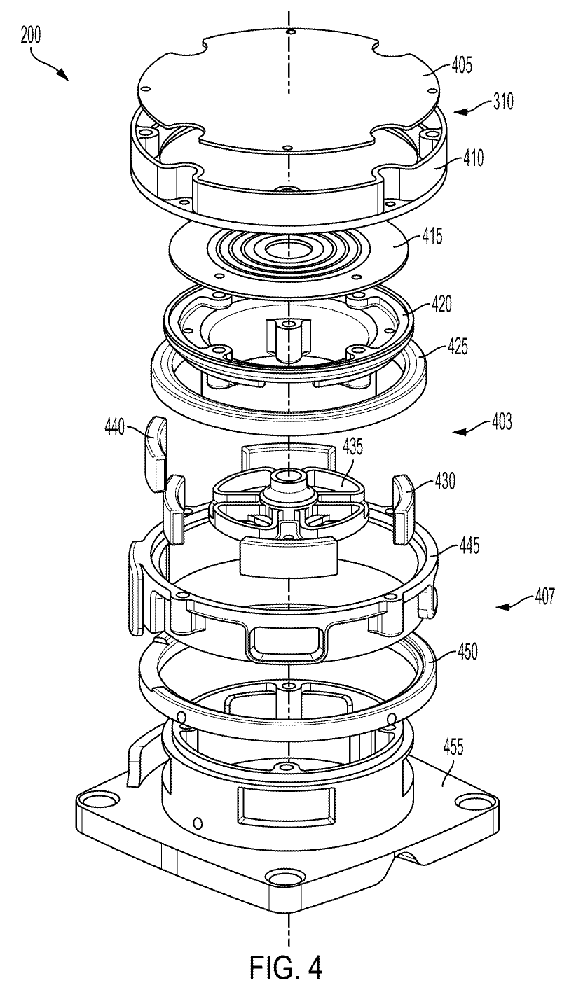

FIG. 4 depicts a perspective view of the assembly 200, in accordance with some aspects. The perspective view of the assembly 200 can refer to or represent an expanded view of one or more components of the assembly 200. Stated otherwise, one or more components, as shown in FIG. 4, are separated from one another. The assembly 200 can include at least one carrier assembly 403. The carrier assembly 403 can electrically couple the display assembly 310 with one or more components of the bike 100. For example, carrier assembly 403 can electrically couple the display assembly 310 with the battery pack 105. The carrier assembly 403 can electrically couple the display assembly 310 with one or more components via one or more of cabling, cords, printed circuit board (PCB) wires, or other possible electrical connectors.

The carrier assembly 403 can receive or otherwise accept the display assembly 310. For example, the display assembly 310 can be inserted into the carrier assembly 403. The carrier assembly 403 can support the display assembly 310. For example, the carrier assembly 403 can provide structural support to the display assembly 310. The carrier assembly 403 can provide structural support by at least one of stabilizing or securing a position or placement of the display assembly 310.

The display assembly 310 can be movably coupled with the carrier assembly 403. For example, the display assembly 310 can be secured to the carrier assembly 403 while also being able to move independent from or separate from the carrier assembly 403. Stated otherwise, the display assembly 310 can rotate about an axis while the position or placement of the carrier assembly 403 is maintained. For example, at least one of the selector element 315 or the display device 320 can rotate or otherwise move independent or relative to the carrier assembly 403. Stated otherwise, the selector element 315 can rotate by an angular amount while the position or orientation of the carrier assembly 403 is maintained.

The display assembly 310 can include at least one display driver board 405 and display driver carrier 410. The display driver board 405 can house or otherwise support the display device 320. The display driver board 405 and the trace board 415 can refer to or include at least one of a printed circuit board, flexible printed circuits, electronic moldings, or other possible electronic circuitry. The display driver carrier 410 can house or secure the display driver board 405. For example, the display driver carrier 410 can represent a sub-housing for which the display device 320 is housed or otherwise located within the housing 305.

The display driver board 405 can refer to or include one or more of processing circuits, processors coupled with memory, systems-on-chip, single board computers, or another possible circuitry. For example, the display driver board 405 can include or otherwise interface with the controller 205. The display driver board 405 can determine, monitor, or otherwise identify a placement of the display assembly 310. For example, the display driver board 405 can determine a placement of the display device 320 within space. Stated otherwise, the display driver board 405 can determine a position of the display device 320 relative to one or more axes.

The display driver board 405 can determine the position of the display device 320 based on one or more interactions with the selector element 315. For example, as the selector element 315 is rotated by 45 degrees, the display driver board 405 can determine a position of the display device 320. Stated otherwise, the display driver board 405 can relate the position of the display device 320 to that of the position of the selector element 315. The display driver board 405 can control the display device 320 to present information. For example, the display driver board 405 can cause the display device 320 to present one or more graphical user interfaces.

The display driver board 405 can control an orientation or placement of the information, presented by the display device 320, such that the information is presented in accordance with a position of the display device 320. For example, if the display device 320 is rotated by 90 degrees, the display driver board 405 can control the display device 320 such that the information is not also rotated by 90 degrees. As another example, the display driver board 405 can control the display device 320 such that the display information is not rotated with the display device 320. Stated otherwise, the visual depiction or orientation of graphical images, graphical user interfaces, or digital content (as displayed by the display device 320) can be maintained even as the display device 320 is rotated or moved. The maintaining of the graphical images can result in a presentment of information (by the display device 320) having a consistent orientation or depiction such that the orientation is unchanged or remains the same even as the display device 320 is rotated.

The display driver board 405 can include one or more components, elements, or electrical devices to monitor, track, detect, or identify changes in a position or orientation of the display device. For example, the display driver board 405 can include contacts which are activated or deactivated based on respective movement of the display device 320. The activation or deactivation of the contacts can provide an indication of a location or change in location of the display device 320. As another example, the display driver board 405 can include an encoder or an inertial measurement unit (IMU) to track or monitor rotation of the display device 320. For example, the encoder can detect one or more instances in which the display device 320 is rotated by a given angle or amount.

The carrier assembly 403 can include at least one trace board 415, a trace board carrier 420, a bearing 425, one or more magnets 430, a magnet holder 435, one or more magnets 440, a magnet holder 445, one or more spring detents or spring detent ring (shown as spring detent 450), and a base 455. The magnets 440 can refer to or include ring magnets. The magnets 430 can refer to or include at least one of core magnets or hall magnets. The magnets 440 or the magnets 430 can define or represent one or more detents of the assembly 200. For example, the magnets 440 and the magnets 430 can define one or more degrees of freedom for which the selector element 315 can rotate. As another example, the magnets of the assembly 200 can define a range of motion for the selector element 315.

The carrier assembly 403 can include at least one detent assembly 407. The detent assembly 407 can include one or more components of the carrier assembly 403. For example, the detent assembly 407 can include the magnet holder 445, the magnets 430, the magnets 440, and the magnet holder 435. The detent assembly 407 can couple with the base 455. For example, the detent assembly 407 can secure the magnet holder 445 to the base 455. The detent assembly 407 can couple with the base 455 such that a position or placement of one or more components of the carrier assembly 403 is maintained. The detent assembly 407 can define one or more positions for the selector element 315. For example, the detent assembly 407 (based on the position or placement of the magnets) can define the range of motion for the selector element 315. As another example, the detent assembly 407 can include one or more ridges and grooves which define the range of motion for the selector element 315.

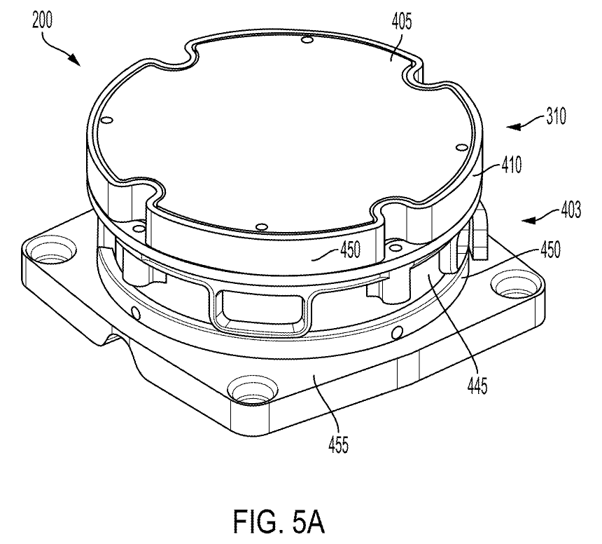

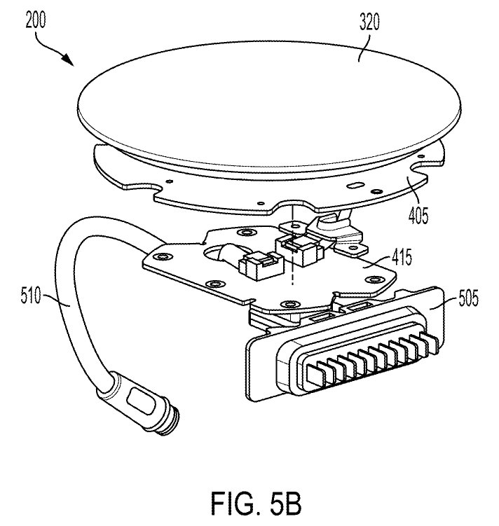

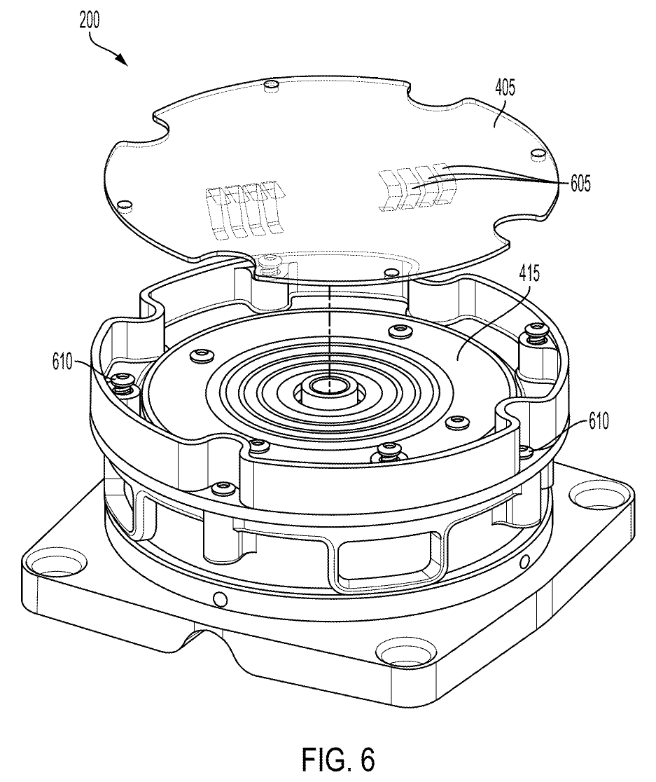

FIGS. 5A, 5B, and 6 depict the assembly 200, in accordance with some aspects. The display assembly 310 can be coupled with the carrier assembly 403. For example, as shown in FIG. 6, the display driver carrier 410 can be coupled with the magnet holder 445 via one or more fasteners 610. As another example, as shown in FIG. 6, the display driver board 405 can be electrically coupled with the trace board 415 via one or more connectors 605 (shown as spring connectors). As shown in FIG. 5B, the assembly 200 includes at least one connector cable (shown as cable 510) and at least one connector port (shown as port 505). The cable 510 can electrically couple the assembly 200 or one or more components thereof with one or more components of the bike 100. For example, the cable 510 can electrically couple the assembly 200 with the battery pack 105. The port 505 can electrically couple the assembly 200 with one or more components of the bike 100. For example, the port 505 can couple the assembly 200 with a controller or control device of the bike 100.

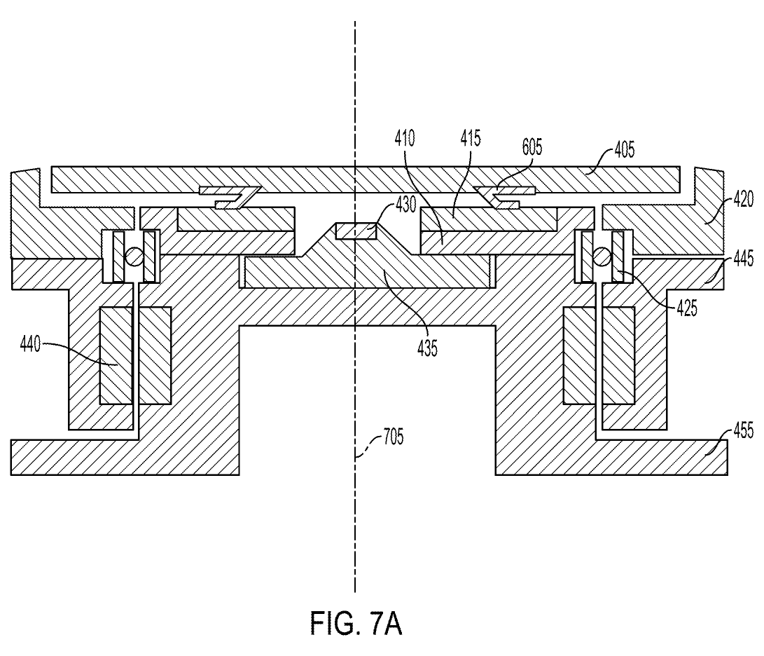

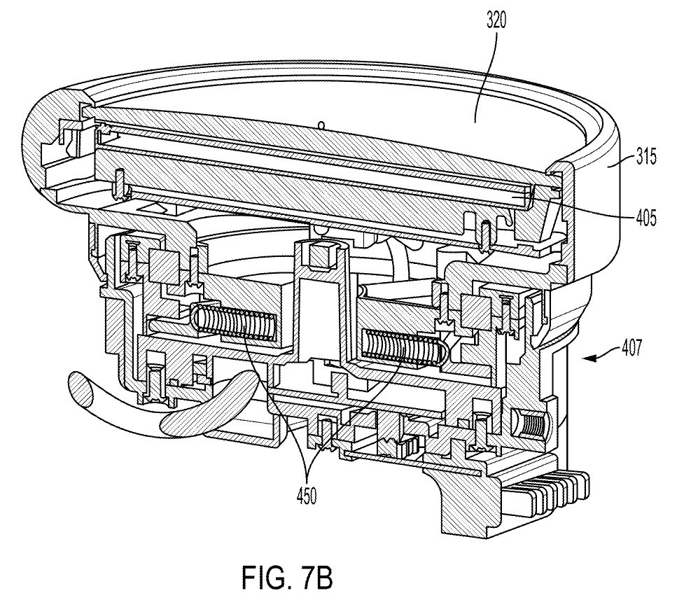

FIGS. 7A and 7B depicts a cross-sectional view of the assembly 200, in accordance with some aspects. The magnets 440, as shown in FIG. 7A, can define one or more stop points for the selector element 315. For example, the magnets 440 can be located at one or more points in space such that a magnet of the selector element 315 is stopped or otherwise slowed by the magnets 440. The magnets 440 stopping or slowing the selector element 315 can provide feedback, to an operator of the bike 100, regarding one or more placements or positions for the selector element 315. As shown in FIG. 7A, the display driver board 405 can move relative to the carrier assembly 403 via the bearing 425. For example, the bearing 425 provides an area or opening for which the display driver board 405 can rotate, relative to the carrier assembly 403. As shown in FIG. 7B, the spring detent 450 can be centrally located, relative to one or more of the display device 320, the display driver board 405, or the selector element 315.

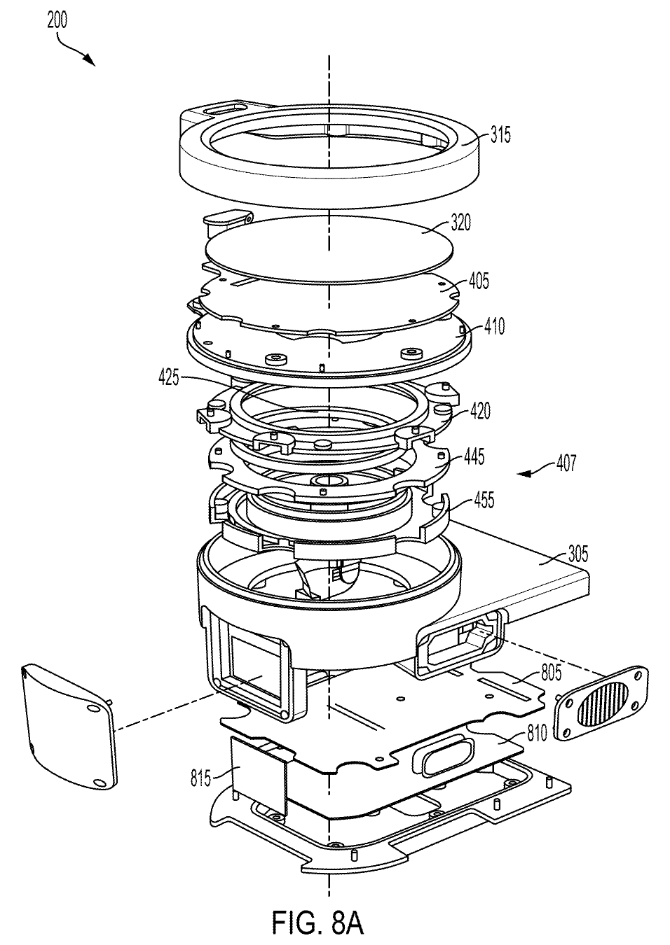

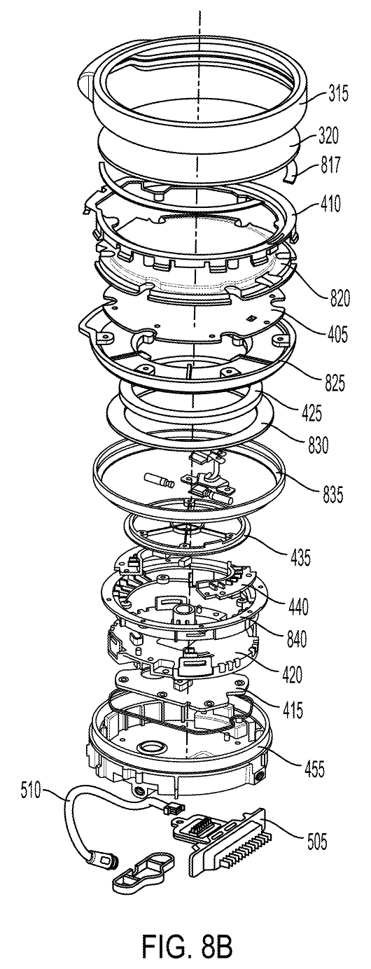

FIGS. 8A and 8B depict a perspective view of the assembly 200, in accordance with some aspects. The perspective view, as shown in FIG. 8A, of the assembly 200 can refer to or represent an expanded view of one or more components of the assembly 200. Stated otherwise, one or more components, as shown in FIG. 8A, are separated from one another. The assembly 200 can include one or more of processing circuits, processors coupled with memory, circuitry, or printed circuit boards. For example, as shown in FIG. 8A, the assembly 200 includes a printed circuit board 805, a printed circuit board 810, and a printed circuit board 815.

As shown in FIG. 8B, the assembly 200 includes trace tape 817, a heat sink 820, an enclosure 825, an upper bearing clamp 830, a seal 835, and a lower bearing clamp 840. The trace tape 817 can couple the display device 320 with the display driver carrier 410. The heat sink 820 can disperse heat produced by the display device 320. The enclosure 825 can couple with the selector element 315 to enclose or cover one or more segments or elements of the assembly 200. The upper bearing claim 830 can couple the bearing 425 with the enclosure 825. The seal 835 can insulate or isolate one or more components of elements of the assembly 200. The lower bearing clamp 840 can couple the springs detent 450 (or one or more springs thereof) or the magnets 430 with the trace board carrier 420.

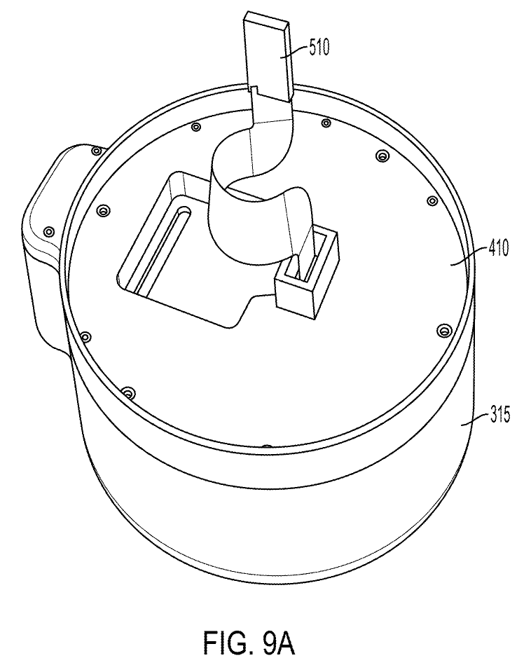

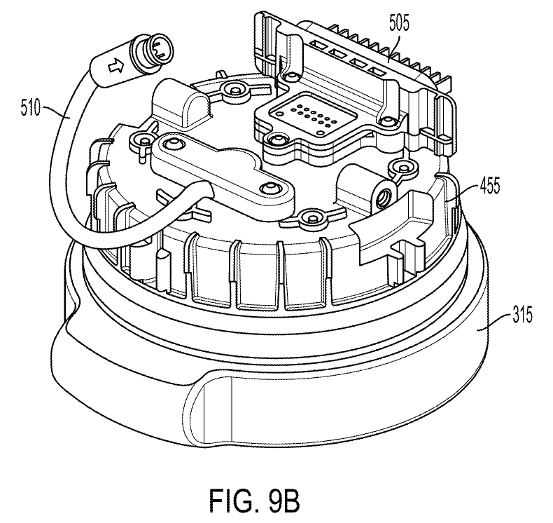

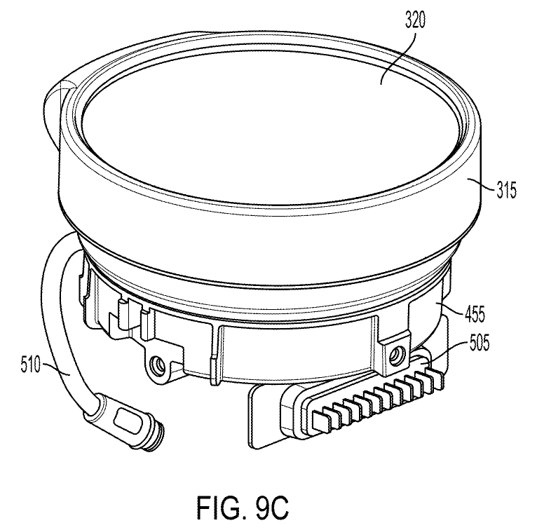

FIGS. 9A, 9B, and 9C depict the display assembly 310, in accordance with some aspects. As shown in FIG. 9A, the selector element 315 and the display driver carrier 410 can surround or otherwise enclose the display device 320. For example, the display driver carrier 410 can represent a first enclosure and the selector element 315 can represent a second enclosure. The display driver carrier 410 can movably couple with the carrier assembly 403. The display driver carrier 410 can at least partially surround a first portion of the display device 320. For example, the display driver carrier 410 can surround a bottom side of the display device 320. As shown in FIG. 9B, the selector element 315 can be coupled with the base 455. The coupling of the selector element 315 with the base 455 can create or otherwise establish a seal of the assembly 200. As shown in FIG. 9C, the display device 320 can be sealed or insulated based at least in part on the selector element 315 having been coupled with the base 455.

The selector element 315 and the display driver carrier 410 can be coupled with one another. For example, the selector element 315 can couple with the display driver carrier 410 to isolate the display device 320 or one or more portions thereof from an external environment. For example, the selector element 315 can couple with the display driver carrier 410 to isolate the display device 320 from dust or water. The display assembly 310 can be electrically coupled with at least one connector (shown as the cable 510). The cable 510 can include at least one of the various connectors described herein. The cable 510 can electrically couple the display assembly 310 with one or more components of the assembly 200 or the bike 100.

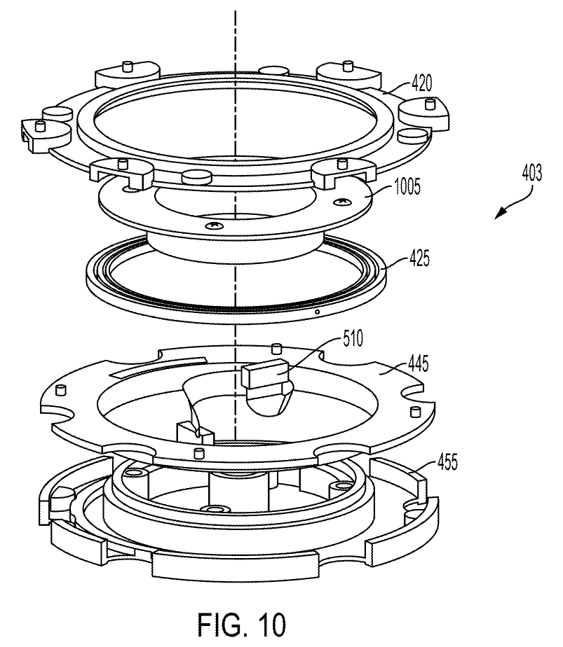

FIG. 10 depicts a perspective view of the carrier assembly 403, in accordance with some aspects. The perspective view of the carrier assembly 403, as shown in FIG. 10, can refer to or represent an expanded view such that one or more components of the carrier assembly 403 are shown separated from one another.

The carrier assembly 403 can include at least one flange 1005. The flange 1005 can support or otherwise secure one or more components of the carrier assembly 403. For example, the flange 1005 can provide support to the bearing 425. The carrier assembly 403 can be electrically coupled with the cable 510. For example, the carrier assembly 403 can include one or more ports or inserts for which the cable 510 can be inserted or otherwise received.

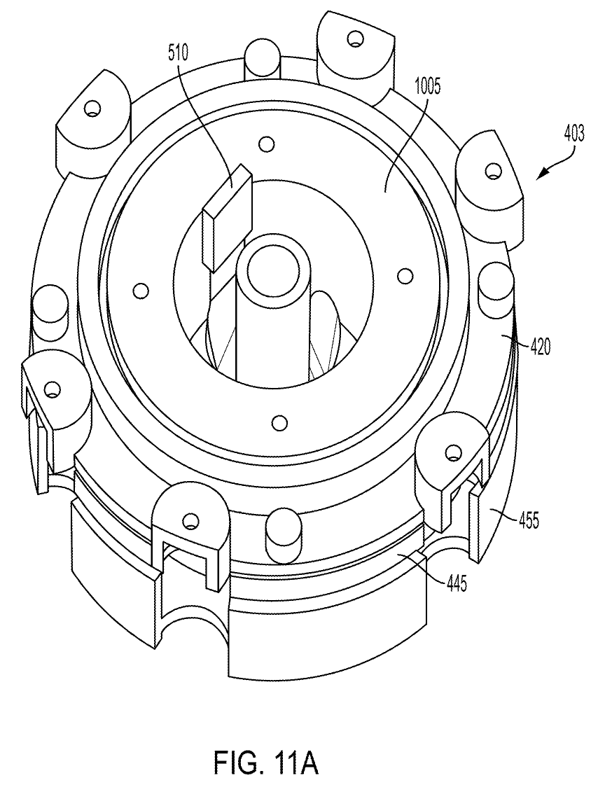

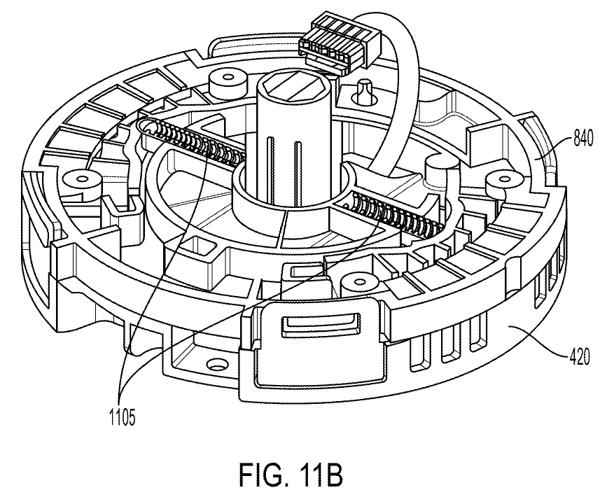

FIGS. 11A and 11B depict perspective views of the carrier assembly 403, in accordance with some aspects. The carrier assembly 403 can include one or more of indents, recesses, grooves, or other possible voids for which the cable 510 (or a portion thereof) can be located. The cable 510 can be free to move with the display assembly 310 such that the display assembly 310 remains electrically coupled with the carrier assembly 403 while the display assembly rotates or otherwise moves.

As shown in FIG. 11B, the assembly 200 includes one or more springs (shown as springs 1105) are disposed interior to or within a radius of the trace board carrier 420. Stated otherwise, the springs 1105 can be centrally located relative to the trace board carrier 420. The springs 1105 can be compresses or expanded based on movement (e.g., rotation) of the display assembly 310. For example, the springs 1105 can be coupled with the display assembly 310 such that springs 1105 lengthen or contrast based on a direction of rotation of the display assembly 310.

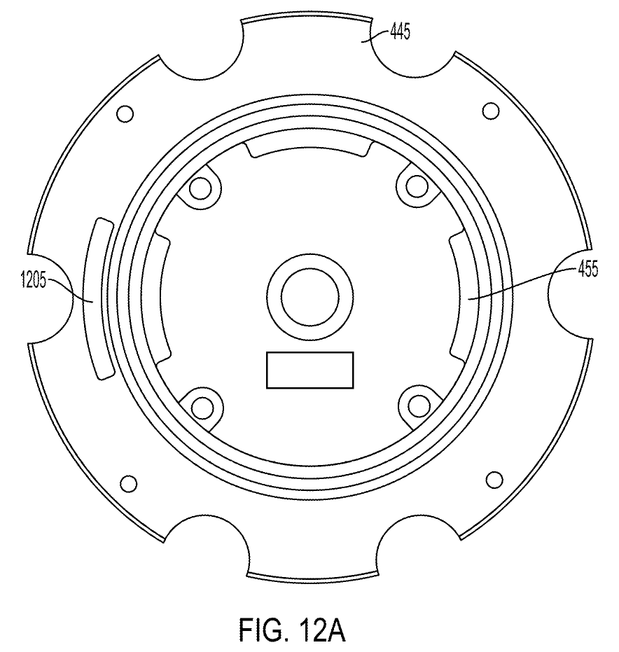

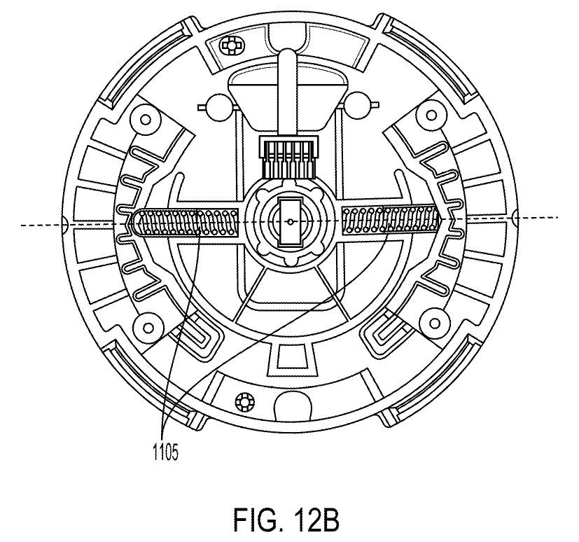

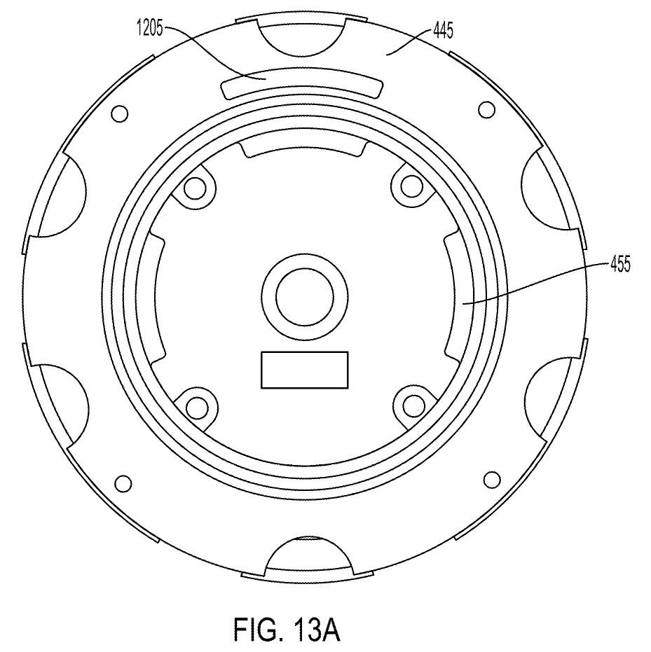

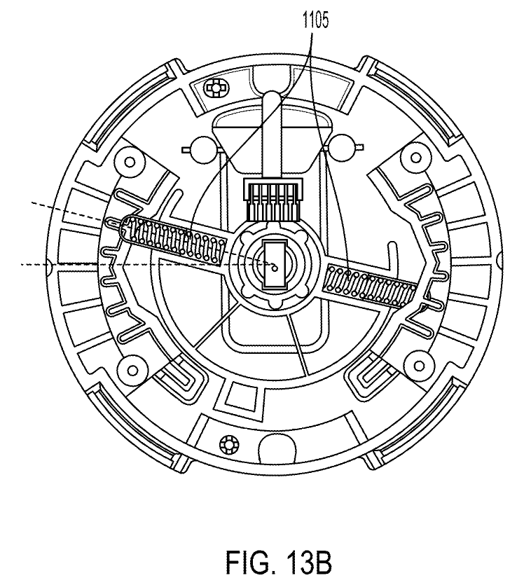

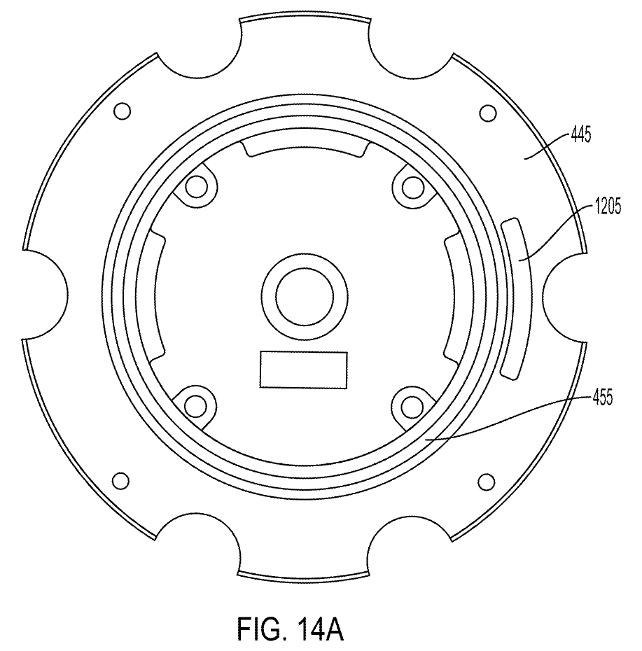

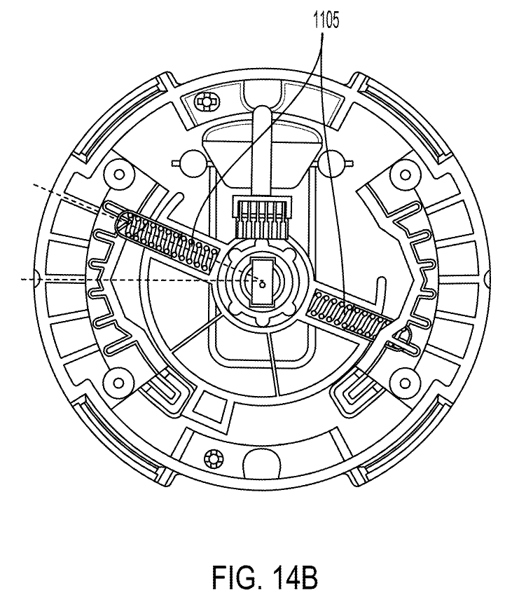

As described herein, the carrier assembly 403 can include one or more magnets which define one or more detents for which the selector element 315 can move or otherwise rotate. For example, as shown in FIG. 12A, a detent 1205 is shown to be defined by the magnets of the carrier assembly 403. The detent 1205, as shown in FIG. 12A, can correspond to the position of the selector element 315 as shown in FIG. 3A. As another example, as shown in FIG. 13A, the detent 1205 can correspond to the position of the selector element 315 as shown in FIG. 3B. As another example, as shown in FIG. 14A, the detent 1205 can correspond to the position of the selector element 315 as shown in FIG. 3C.

As described herein, the carrier assembly 403 can include one or more springs which define one or more detents for which the selector element 315 can move or otherwise rotate to store potential energy to return the selector element 315 to a nominal or default position. For example, as shown in FIG. 12B, the springs 1105 can include a default, standard, or nominal position for which the display assembly 310 is in a resting position. The position of the springs 1105 (as shown in FIG. 12B) can represent a position of the springs 1105 while the springs are not compressed or extended. In contrast, as shown in FIG. 13B, the springs 1105 are shown as having been extended due to a rotation of the display assembly 310. The extension of the springs 1105 can bring about a storage of potential energy by the springs 1105. Relative to the springs 1105 (in FIG. 13B), FIG. 14B depicts an example of the springs 1105 having been further extend. The springs 1105 (as shown in FIG. 13B or 14B) can result from the display assembly 310 having been rotated or moved by a certain amount or angle.

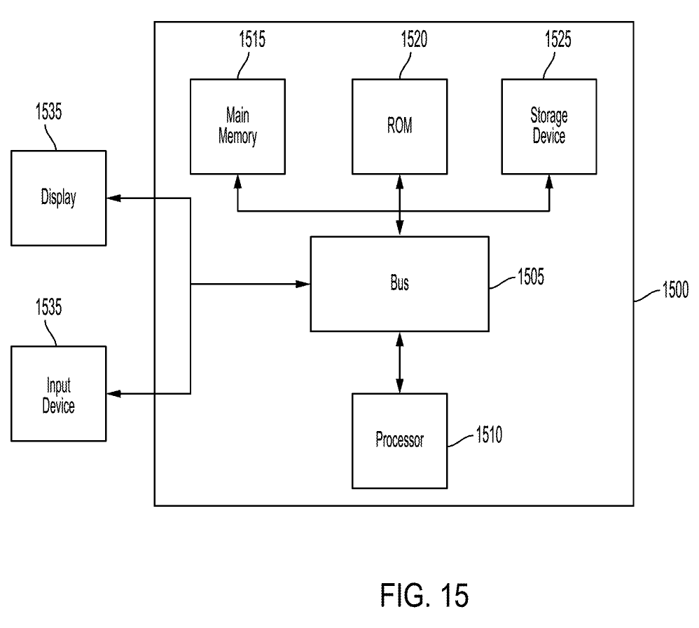

FIG. 15 is a block diagram illustrating an architecture for a computer system 1500 that can be employed to implement elements of the systems, methods, and assemblies described and illustrated herein. For example, the computer system 1500 can be included in or house in the display driver board 405. The computing system 1500 can include at least one bus 1505 or other communication component for communicating information and at least one processor 1510 or processing circuit coupled to the bus 1505 for processing information. The computing system 1500 can also include one or more processors 1510 or processing circuits coupled to the bus for processing information. The computing system 1500 also includes at least one main memory 1515, such as a random access memory (RAM) or other dynamic storage device, coupled to the bus 1505 for storing information, and instructions to be executed by the processor 1510. The main memory 1515 can be used for storing information during execution of instructions by the processor 1510. The computing system 1500 may further include at least one read only memory (ROM) 1520 or other static storage device coupled to the bus 1505 for storing static information and instructions for the processor 1510. A storage device 1525, such as a solid-state device, magnetic disk or optical disk, can be coupled to the bus 1505 to persistently store information and instructions.

The computing system 1500 may be coupled via the bus 1505 to a display 1535, such as a liquid crystal display, or active-matrix display, for displaying information to a user such as a rider of the bike 100 or another end user. An input device 1530, such as a keyboard or voice interface may be coupled to the bus 1505 for communicating information and commands to the processor 1510. The input device 1530 can include a touch screen display 1535. The input device 1530 can also include a cursor control, such as a mouse, a trackball, or cursor direction keys, for communicating direction information and command selections to the processor 1510 and for controlling cursor movement on the display 1535.

The processes, systems and methods described herein can be implemented by the computing system 1500 in response to the processor 1510 executing an arrangement of instructions contained in main memory 1515. Such instructions can be read into main memory 1515 from another computer-readable medium, such as the storage device 1525. Execution of the arrangement of instructions contained in main memory 1515 causes the computing system 1500 to perform the illustrative processes described herein. One or more processors in a multi-processing arrangement may also be employed to execute the instructions contained in main memory 1515. Hard-wired circuitry can be used in place of or in combination with software instructions together with the systems and methods described herein. Systems and methods described herein are not limited to any specific combination of hardware circuitry and software.

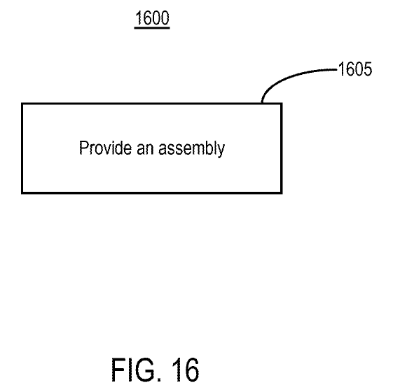

FIG. 16 is a block diagram of a process 1600, according to some aspects. The process 1600 can be performed or implemented during an assembly process or manufacture process of the bike 100 or one or more components thereof. For example, the process 1600 can be performed when the frame 120 is adhered to or otherwise attached to one or more additional components of the bike 100.

At act 1605, an assembly can be provided. For example, the assembly 200 can be provided. As another example, one or more components, sub-assemblies, or elements of the assembly 200 can be provided. The assembly 200 can be provided during the manufacture of the bike 100. The assembly 200 can be retrofitted or otherwise added to the bike 100 subsequent to assembly of the bike 100. The providing of the assembly 200 can include the providing or otherwise making available the components, elements, or sub-assemblies of the assembly 200. For example, the display assembly 310 can be provided during act 1605.

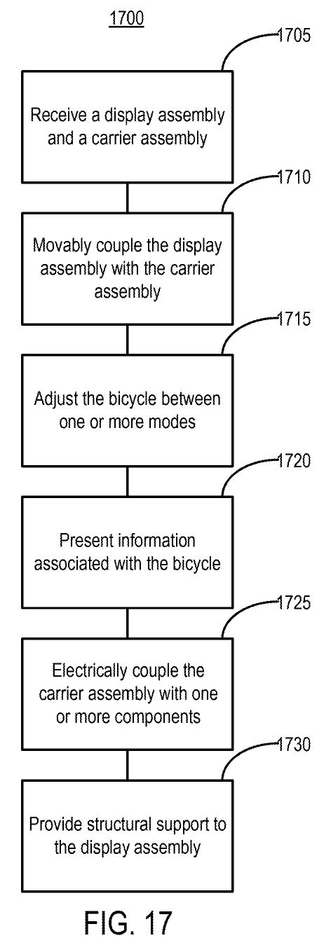

FIG. 17 is a block diagram of a process 1700, according to some aspects. The process 1700 can be performed or implemented during an assembly process or manufacture process of the bike 100 or one or more components thereof. For example, the process 1700 can be performed when the frame 120 is adhered to or otherwise attached to one or more additional components of the bike 100. The process 1700 or one or more acts or steps of the process 1700 can be combined, separated, omitted, skipped, repeated, or otherwise altered. For example, a single act can be separated into two or more acts. As another example, a first act can be combined with a second act of the process 1700.

At act 1705, a display assembly and a carrier assembly can be received. For example, the housing 305 can receive the display assembly 310 and the carrier assembly 403 by at least one of placing, positioning, locating, or otherwise situated the display assembly 310 and the carrier assembly 403 within the housing 305. The housing 305 can receive the display assembly 310 and the carrier assembly 403 to secure, attach, affix, or otherwise couple the display assembly 310 and the carrier assembly 403 to the bike 100.

At act 1710, the display assembly can be movably coupled with the carrier assembly. For example, the display assembly 310 can be coupled with the carrier assembly 403 such that the display assembly 310 can move independent from, relative to, or without corresponding movement of the carrier assembly 403. Stated otherwise, the display assembly 310 can move such that a position of the carrier assembly 403 does not change.

At act 1715, the bicycle can be adjusted between one or more modes. For example, a rotation or movement (of the selector element 315) can trigger the bike 100 to switch between modes. The bike 100 can switch between an idle mode to a locked mode. As another example, the bike 100 can switch from an operator assist mode to a manual drive mode.

At act 1720, information associated with a bicycle can be presented. For example, the display device 320 can generate, display, or otherwise provide at least one user interface to graphically or digitally present information associated with the bike 100. The information can include one or more of a current mode of the bike 100, operating metrics of the bike 100 (e.g., speed, distance traveled, etc.). The display device 320 can present the information to provide for positive affirmation (to the operator of the bike 100) that the bike is being adjusted between modes. For example, the display device 320 can present a certain view or image to indicate a respective mode of the bike 100.

At act 1725, the carrier assembly can be electrically coupled with one or more components. For example, the carrier assembly 403 can be electrically coupled with the battery pack 105. As another example, the carrier assembly 403 can be electrically coupled with a controller or control device of the bike 100. The carrier assembly 403 can be electrically coupled with one or more components to provide for the delivery of electrical power to the assembly 200. The carrier assembly 403 can be electrically coupled with the one or more components to facilitate the exchange, transmission, deliver, or receipt of one or more signals by the assembly 200.

At act 1730, structural support can be provided to the display assembly. For example, the carrier assembly 403 can provide structural support to the display assembly 310 such that the position (on the housing 305) of the display assembly 310 is maintained. As another example, the carrier assembly 403 can provide rigidity or stability to the display assembly 310.

The micromobility device (referred to herein as bike 100) can be or include at least one drive unit (e.g., a propulsion system), at least one wheel, at least one battery pack, and a frame. The drive unit, the wheel, and the battery pack can be coupled with the frame. The drive unit can rotate the wheel to propel the micromobility device. The micromobility device can include the battery pack to power the drive unit and rotate the wheel with or without application of a mechanical force to a pedal assembly by the user. For example, the micromobility device can the propelled by a mechanical force provided by the user to the pedal assembly, by an electrical force provided by a battery pack to a motor, or some combination thereof. The micromobility device can include single rider bicycles, tandem bicycles, cargo bicycles, motor-assist bicycles, pedicabs, electric-assist bicycles, road bicycles, mountain bicycles, electric scooters, electric skateboards, standing devices, or unicycles, or devices with one, two, three, four or more than four wheels.

In various embodiments, a micromobility device (which may be or include the bike 100) can be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms, as used herein, are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical, or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An assembly for a micromobility device, the assembly comprising:
a housing configured to receive (i) a display assembly and (ii) a carrier assembly;
the display assembly including:
a selector element configured to adjust the micromobility device between one or more modes to change one or more operations of the micromobility device; and
a display device configured to present information associated with the micromobility device;
the display assembly movably coupled with the carrier assembly such that the selector element and the display device move independent from the carrier assembly; and
the carrier assembly configured to:
electrically couple the display assembly with one or more components of the micromobility device; and
provide structural support to the display assembly.

2. The assembly of claim 1, comprising:
the display assembly including a first enclosure configured to:
movably couple with the carrier assembly; and
at least partially surround a first portion of the display device; and
the selector element configured to:
provide a second enclosure to:
at least partially surround a second portion of the display device; and
couple with the first enclosure to isolate at least one of (i) the first portion of the display device or (ii) the second portion of the display device from an external environment.

3. The assembly of claim 1, comprising:
the carrier assembly including a detent assembly;
the detent assembly configured to couple with a base of the carrier assembly; and
the detent assembly configured to define one or more positions for the selector element to move between to adjust the micromobility device between the one or more modes.

4. The assembly of claim 1, comprising:
a detent assembly disposed within the housing;
the detent assembly coupled with the selector element; and
the detent assembly including one or more springs to define one or more points of rotation for the selector element.

5. The assembly of claim 1, comprising:
the display assembly including a first printed circuit board; and
the first printed circuit board configured to electrically couple with a second printed circuit board of the carrier assembly.

6. The assembly of claim 1, comprising:
a processor, coupled with memory, configured to:
determine, responsive to one or more interactions with the selector element, a position of the display device within space; and
control the display device to maintain a presentment and an orientation of the information associated with the micromobility device based at least on the position of the display device.

7. The assembly of claim 1, comprising:
the housing configured to fixably couple with a portion of the micromobility device, the portion disposed between a first handle of the micromobility device and a second handle of the micromobility device.

8. The assembly of claim 1, comprising:
one or more springs disposed within and supported by the carrier assembly;
the one or more springs coupled with the display assembly;
the one or more springs to store potential energy which results from rotation of the selector element or the display device; and
the one or more springs to return, using the potential energy, the selector element or the display device from a first position to a second position, wherein the second position corresponds to a position of the selector element or the display device prior to the rotation of the display assembly.

9. The assembly of claim 1, comprising:
the display assembly including an enclosure; and
the enclosure to couple with the selector element such that the display device is disposed between the selector element and the enclosure.

10. The assembly of claim 1, wherein the micromobility device is a bicycle, and comprising:
the housing configured to couple with at least one of a down tube of the bicycle or a stem of the bicycle.

11. The assembly of claim 1, comprising:
the selector element and the display device configured to move in unison and relative to the carrier assembly.

12. A bicycle, comprising:
an assembly, comprising:
a housing configured to receive (i) a display assembly and (ii) a carrier assembly;
the display assembly including:
a display device configured to present information associated with the bicycle;
the display assembly movably coupled with the carrier assembly such that the display device moves independent from the carrier assembly during a selection of at least one mode of the bicycle; and
the carrier assembly configured to:
electrically couple the display assembly with one or more components of the bicycle; and
provide structural support to the display assembly.

13. The bicycle of claim 12, comprising:
the display assembly including:
a first enclosure configured to:
movably couple with the carrier assembly; and
at least partially surround a first portion of the display device; and
a second enclosure configured to:
at least partially surround a second portion of the display device; and
couple with the first enclosure to isolate at least one of (i) the first portion of the display device or (ii) the second portion of the display device from an external environment.

14. The bicycle of claim 12, comprising:
the carrier assembly including a detent assembly;
the detent assembly to couple with a base of the carrier assembly; and
the detent assembly configured to define one or more positions for a selector element of the display assembly to move between during the selection of the at least one mode.

15. The bicycle of claim 12, comprising:
a detent assembly disposed within the housing;
the detent assembly coupled with a selector element of the display assembly; and
the detent assembly including one or more springs to define one or more points of rotation for the selector element.

16. The bicycle of claim 12, comprising:
the display assembly including a first printed circuit board; and
the first printed circuit board configured to electrically couple with a second printed circuit board of the carrier assembly.

17. The bicycle of claim 12, comprising:
a processor, coupled with memory, configured to:
determine, responsive to one or more interactions with a selector element of the display assembly, a position of the display device within space; and
control the display device to maintain a presentment and an orientation of the information associated with the bicycle based at least on the position of the display device.

18. The bicycle of claim 12, comprising:
the display assembly including an enclosure; and
the enclosure to couple with a selector element of the display assembly such that the display device is disposed between the selector element and the enclosure.

19. A method, comprising:
providing an assembly for a bicycle, the assembly including:
a housing configured to receive (i) a display assembly and (ii) a carrier assembly;
the display assembly including:
a selector element configured to adjust the bicycle between one or more modes to change one or more operations of the bicycle; and
a display device configured to present information associated with the bicycle;
the display assembly movably coupled with the carrier assembly such that the selector element and the display device move independent from the carrier assembly; and
the carrier assembly configured to electrically couple the display assembly with one or more components of the bicycle.

20. The method of claim 19, wherein:
the display assembly includes a first enclosure configured to:
movably couple with the carrier assembly; and
at least partially surround a first portion of the display device; and
the selector element is configured to:
provide a second enclosure to:
at least partially surround a second portion of the display device; and
couple with the first enclosure to isolate at least one of (i) the first portion of the display device or (ii) the second portion of the display device from an external environment.
